(19) United States
(12) Patent Application Publication
(10) Pub. No.: US 2006/0018996 A1
(43) Pub. Date: Jan. 26, 2006

(54) Automatic discovery of a storage configuration method and apparatus

(76) Inventors: Paul Wayne Pollock, Nashville, TN (US); Roger Bryan Greenway JR., Franklin, TN (US); John Randall Vinson, Franklin, TN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/182,068

(22) Filed: Jul. 15, 2005

Related U.S. Application Data
(63) Continuation-in-part of application No. 10/887,355, filed on Jul. 9, 2004.
(60) Provisional application No. 60/588,340, filed on Jul. 16, 2004.

(51) Int. Cl. A21D 8/02; A21D 2/00

(52) U.S. Cl. 426/19

(57) ABSTRACT

A method and apparatus for determining the configuration of storage device within an inner chamber by locating the device through a relief located on the storage device and subsequently identifying the type of storage device by extracting information from an identification tag.

### CROSS-REFERENCE TO RELATED APPLICATIONS

The present application claims priority to Provisional U.S. Patent Application entitled, “Automatic Discovery of Labware Storage Configuration,” filed Jul. 16, 2004 and having been assigned Ser. No. 60/588,340. The disclosure of the above-cited Provisional Patent Application is hereby incorporated herein by reference in its entirety. The present application also claims priority to and is a continuation-in-part of U.S. Patent Application entitled “Microplate Storage Hotel Design,” filed Jul. 9, 2004, now pending, and having been assigned Ser. No. 10/887,355, the disclosure of which is hereby also hereby incorporated herein by reference in it entirety.

### FIELD OF THE INVENTION

The present invention relates generally to storage device configuration within a chamber. More particularly, the present invention relates to automatically determining the configuration of storage devices with the chamber.

### BACKGROUND OF THE INVENTION

Determining and achieving the proper conditions that allow a protein to crystallize from solution often require many attempts before the proper concentrations of protein and reagents are determined and achieved. Furthermore, even when the conditions permit crystallization, the rate of crystallization is often very slow, at times on the order of weeks or even months. As a result, manually performing protein crystallization experiments is a very labor and time intensive process. One method of increasing the chances of obtaining protein crystals in the first experiment, thus saving a significant amount of time, is to try as many different protein and reagent concentrations as possible in the initial experiment.

Because protein crystallization experiments have traditionally been carried out in microplates, microplate storage hotels have been developed to store the numerous microplates prepared during the course of the experiment. Furthermore, because the preparing of the vast number of microplates and the periodic checking of each microplate for protein crystals are so labor intensive, automated protein crystallizers have been developed. These automated protein crystallizers are capable of utilizing multiple microplate storage hotels to increase the number of conditions that can be tested in a single experiment. The multiple microplate storage hotels of an automated protein crystallizer provide high density storage of microplates, but also make up a significant fraction of the total cost of the crystallizer.

One problem with, or disadvantage of the automated protein crystallizer is that these storage hotels are frequently displaced or repositioned within these machines. Because the machines are automated, the protein crystallizer needs to be aware of the contents within it at all times as this configuration information is used by an automated storage/retrieval system so that the elements within the hotels can be accessed.

Accordingly, it is desirable to provide a method and apparatus to determine the reconfiguration such that system down time is minimized.

### SUMMARY OF THE INVENTION

The foregoing needs are met, to a great extent, by the present invention, wherein in some embodiments an apparatus is provided that integrates a plurality of shelving members and locating members with a pair of side panels for the construction of a microplate storage hotel. In addition, in some embodiments of the invention the microplate storage hotel has a base plate with integrated features that provide hotel position, alignment and registration information.

In accordance with one embodiment of the present invention, an apparatus for detecting the type of storage unit includes a storage unit for holding differing types of labware, a relief located on the storage unit, wherein the relief is configured to locate the position of the storage unit, and a sensor that is configured to detect the relief.

In accordance with another embodiment of the present invention, a method for detecting the type of storage unit includes ascertaining a location for a relief in the storage unit and in response to locating the relief, determining the type of storage unit by extracting information from an identification tag located on or near the storage unit.

In accordance with another embodiment of the present invention, a method for determining the storage unit's position is provided. The method includes locating the right edge of the positioning slot associated with the storage unit, locating the left edge of the positioning slot associated with the storage unit, and locating the top edge of the positioning slot associated with the storage unit.

In accordance with another embodiment of the present invention, a method for aligning and registering the storage unit is provided. The method includes fitting an alignment bar into an alignment slot on the base plate, and then scanning a barcode located on the surface defining the positioning slot on the base plate.

In accordance with another embodiment of the present invention, a system for detecting the type of storage unit includes means for ascertaining a location for a relief in the storage unit and means for determining the type of storage unit.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side view of automated plate storage and imaging apparatus for protein crystallization in accordance with an embodiment of the invention.

FIG. 2 is a top view of the automated plate storage and imaging apparatus for protein crystallization shown in FIG. 1.

FIG. 3 is an isometric view illustrating a microplate storage hotel in accordance with an embodiment of the invention.

FIG. 4 is a side view of the microplate storage hotel shown in FIG. 3.

FIG. 5 is a front view of the microplate storage hotel shown in FIG. 3.

FIG. 6 is an isometric view of a side panel of the microplate storage hotel in accordance with an embodiment of the invention.

FIG. 7 is a side view of the side panel of the microplate storage hotel shown in FIG. 6.

FIG. 8 is a front view of the side panel of the microplate storage hotel shown in FIG. 6.

FIG. 9 is an isometric view of a base plate of the microplate storage hotel in accordance with an embodiment of the invention.

FIG. 10 is an isometric view of a top plate of the microplate storage hotel in accordance with an embodiment of the invention.

FIG. 11 is an illustration of a labware handling mechanism in accordance with an embodiment of the present invention.

FIG. 12 is an illustration of the mechanical system that enables the labware handling mechanism to be translated in a number of directions in accordance with an embodiment of the present invention.

FIG. 13 is a front view of the microplate storage hotel illustrating a relief and identification tag in accordance with an embodiment of the present invention.

### DETAILED DESCRIPTION

The invention will now be described with reference to the drawing figures, in which like reference numerals refer to like parts throughout. An embodiment in accordance with the present invention provides a way to store microplates in a high density and cost effective manner in a complex instrument. Furthermore, some embodiments also provide a way to determine the position, alignment and registration of a microplate storage hotel relative to other hotels and to the instrument's frame.

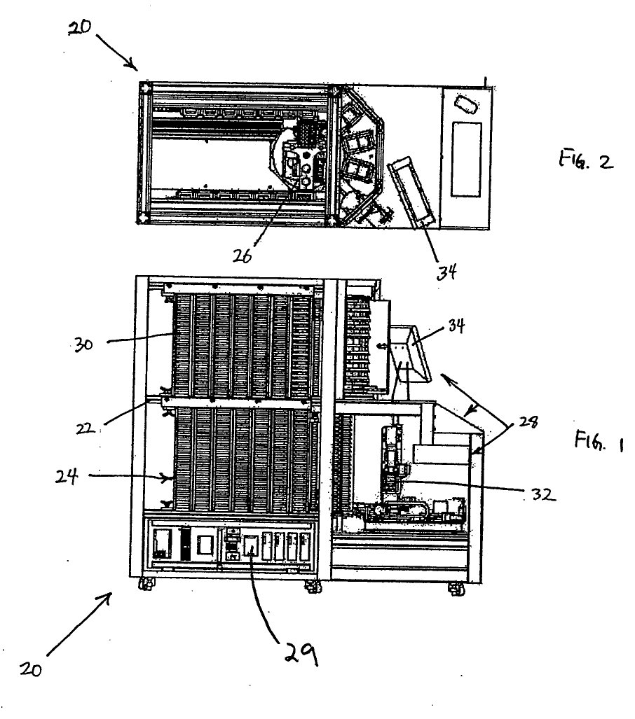

FIG. 1 shows a side view of an automated plate storage and imaging apparatus 20 for protein crystallization. The apparatus 20 has a system frame 22 that supports the housing of multiple microplate storage hotels 24. A robotic microplate handler 26 shown in FIG. 2, controlled by a motion controller 29 and a computer system 28, is used to transfer a microplate 30 to the imager 32. The computer system 28 has a monitor 34 and is used to analyze the data collected by the imager 32. The imager 32 can take images under brightfield, darkfield, and polarized illumination, that can then be analyzed by the computer system 28 for the detection and characterization of protein crystals. The imager 32 can be a charge-coupled device (CCD) camera or other optical, or non-optical imaging device. The computer system 28 is fully programmable to analyze the microplates 30 in any particular order at any defined times. This makes it very simple to determine protein crystal growth kinetics by analyzing a microplate 30 over a period of time.

As shown in FIG. 1, the microplate storage hotels 24 can be stored adjacent to each other in a highly dense configuration on the system frame 22. This allows for a large number of microplates 30 to be stored in a relatively small amount of space, saving valuable laboratory space for other instruments or other purposes.

FIG. 3 is an isometric view of one embodiment of a microplate storage hotel 24. The hotel 24 has two parallel side panels 36 and 38, that are identical to each other. Each side panel 36 and 38 can serve as either the left or right side panel 36 and 38. The two parallel side panels 36 and 38 are connected at one end to a base plate 40 and at the other end to a top plate 42. The connections may be formed by using a rivet, nut and bolt, screw, nail, other mechanical means, welding with solder, welding without solder, arc welding, spot welding, torch welding, other welding means, glue, epoxy, resin, other adhesive means, or by another suitable means to connect objects together. The side panels 36 and 38, base plate 40, and top plate 42 can be constructed out of metal, plastic, wood, or another material suitable for construction purposes. In one embodiment, the side panels 36 and 38 are made of stainless steel while the base plate 40 and top plate 42 are made of aluminum.

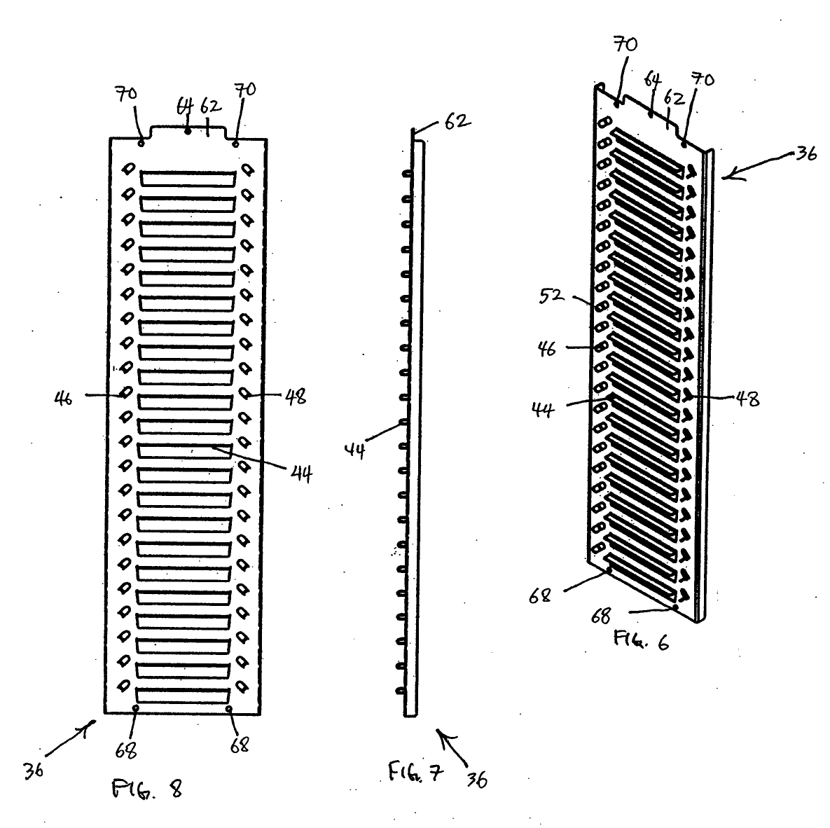

The side panels 36 and 38 have both a plurality of integrated shelving members 44 and a plurality of integrated locating members 46 and 48, which function to hold the microplate 30 (see FIG. 1) and align the microplate 30 in a shelving slot 50, respectively. The integrated locating members 46 and 48 have surfaces 52 (see FIG. 6) positioned at approximately 45 degree angles that help guide the microplate 30 into a shelving slot 50 defined by the shelving members 44 and the side panels 36 and 38. Inserting a microplate 30 into the microplate storage hotel 24 is accomplished by inserting the microplate 30 between the locating members 46 and 48 into the desired shelving slot 50. The locating members 46 and 48 help center the microplate 30 in the shelving slot 50 if the microplate 30 is initially misplaced.

The integrated shelving members 44 are laser cut and punched from the side panels 36 in a manner that results in a row of horizontal shelving members 44 that project into the interior of the microplate storage hotel 24. The integrated locating members 46 and 48 flanking the shelving members 44 are laser cut and punched at the same time as the shelving members 44 from a single template which enhances the precision of the final shelving assembly. The technique of fabricating the integrated shelving members 44 and locating members 46 and 48 is not limited to laser cutting; other fabrication techniques such as mechanically cutting or stamping out the shelving members 44 and locating members 46 and 48 are in accordance with the invention.

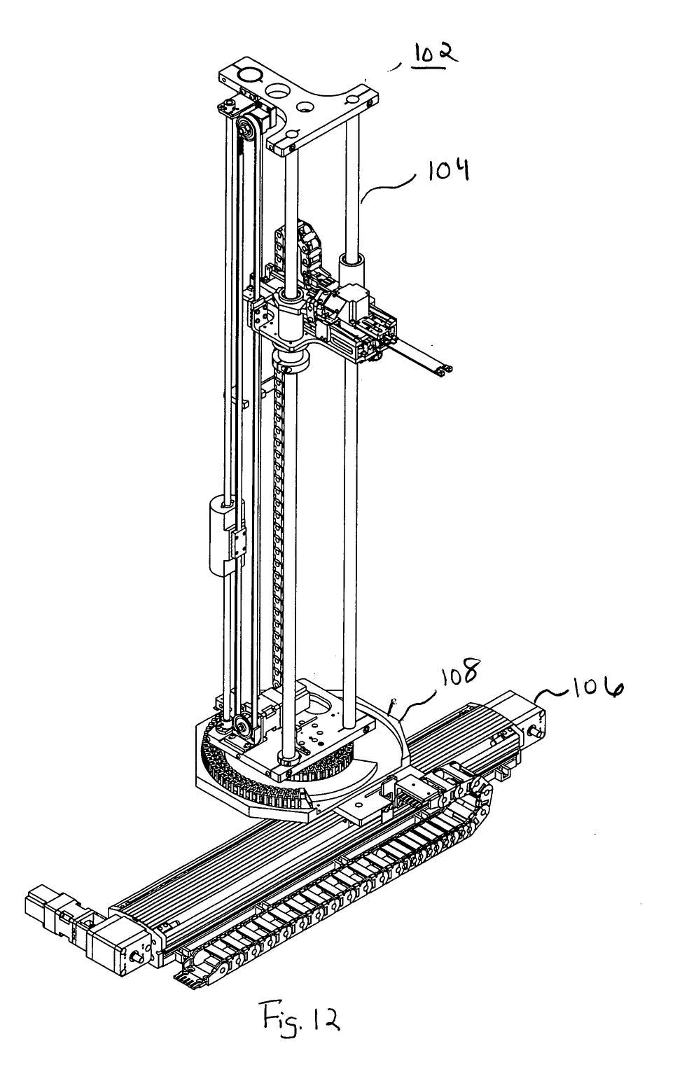

The base plate 40 has a positioning slot 54 that allows the microplate storage hotel's 24 position the be determined with a sensor 98 (see FIG. 11) on the robotic microplate handler 26 (see FIG. 2) that locates either the left edge 56 of the positioning slot 54 or the right edge 58 of the positioning slot 54, and the top edge 60 of the positioning slot 54. Because the positioning slot 54 is both centered on the base plate 40 and made in one width for various embodiments of the hotel 24, the locations of one side edge 56 or 58, and the top edge 60 are sufficient for the sensor 98 on the robotic microplate hander 26 in conjunction with the motion controller 29 (see FIG. 1) to determine the position of the microplate storage hotel 24.

The side panel 36 has an integral locking flap 62 that serves as both a mechanism to lock the microplate storage hotel 24 into place when set in the automated plate storage and imaging apparatus 20 (see FIG. 1) and as an attachment point 64 for a handle 66. The handle 66 can be made of steel, aluminum, another metal or metal alloy, plastic, or another suitable material. The locking flap 62 is engaged by a locking mechanism on the system frame 22 (see FIG. 1).

FIG. 4 shows a side view of one embodiment of the microplate storage hotel 24. The locating members 46 and 48 on the side panels 36 are slanted towards the shelving members 44, and this helps align the microplates 30 (see FIG. 1) on the shelving members 44. A precise positioning of the microplates 30 on the shelving members 44 is necessary for the automated removal and insertion of microplates 30 from the microplate storage hotel 24. Also shown in this figure is the locking flap 62 and handle attachment point 64. Bolts, screws, nails, rivets, welding, or another suitable method can be used to attach the handle 66 to the handle attachment point 64. The two bottom attachment points 68 on the side panel 36 connect the side panel 36 to the base plate 40, while the two top attachment points 70 on the side panel 36 connect the side panel 36 to the top plate 42 depicted in FIG. 3. Bolts, rivets, another mechanical means, welding, or an adhesive can be used at the attachment points 68 and 70.

On the bottom of the base plate 40 is an alignment slot 72. This slot 72 is mated to a corresponding alignment bar located on the system frame 22 (see FIG. 1) to align the microplate storage hotel 24 with the system frame 22. When the alignment bar is fitted into the alignment slot 72, the microplate storage hotel 24 is oriented in the proper direction. After alignment, a sensor on the robotic microplate handler 26 (see FIG. 1) is able to read a barcode 74 located on the base plate 40 depicted in FIG. 3 in order to register the microplate storage hotel 24. Microplate storage hotel 24 registration allows the automated plate storage and imaging apparatus 20 (see FIG. 1) to know what type of microplate storage hotels 24 are being used, and furthermore, registration allows the user to program into the computer system 28 and motion controller 29 (see FIG. 1) customized information regarding each microplate storage hotel 24 and the microplates 30 stored in the hotel 24.

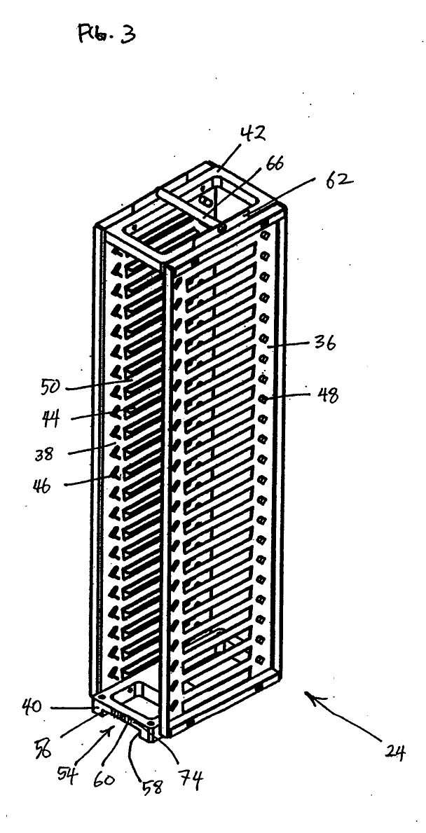

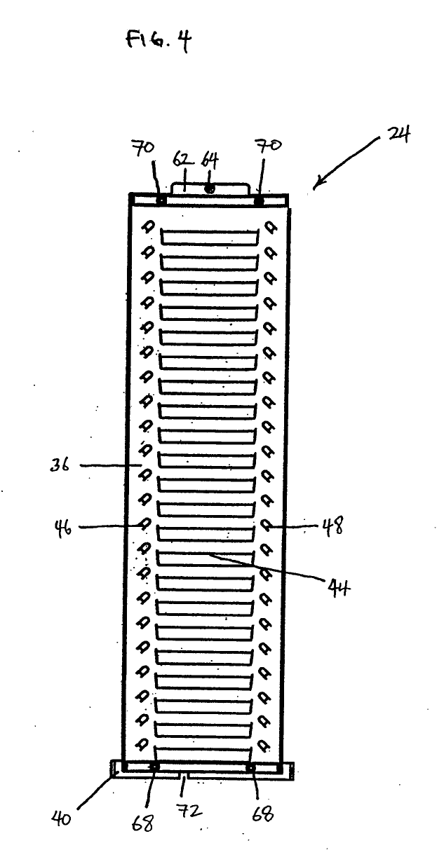

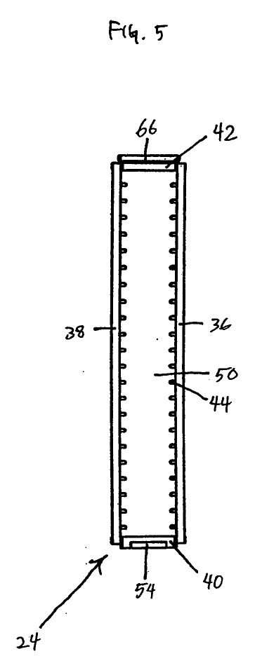

FIG. 5 shows a front view of one embodiment of the microplate storage hotel 24. As shown in FIG. 5, the shelving members 44 project horizontally from the side panels 36 and 38 into the interior of the microplate storage hotel 24 and provide a support for the right and left edges of a microplate 30. The amount of support provided to a microplate 30 (see FIG. 1) can be increased or decreased by varying how far the shelving members 44 project into the interior of the microplate storage hotel 24. The further the shelving member 44 projects into the interior of the microplate storage hotel 24, the more the support that is provided to the microplate 30. The vertical gap between a corresponding pair of shelving members 44, allows the robotic microplate handler 26 (see FIG. 2) to be inserted under the microplate 30, lifted until contact is made with the bottom of the microplate 30, lifted further to separate the microplate 30 from the shelving members 44 and to clear the locating members 46 and 48 (see FIGS. 3 and 4), and finally for the microplate 30 to be removed the from the microplate storage hotel 24.

Insertion of a microplate 30 (see FIG. 1) into the microplate storage hotel 24 occurs in the reverse order as microplate 30 removal. The robotic microplate handler 26 (see FIG. 2) carrying the microplate 30 is inserted into the shelving slot 50 of the microplate storage hotel 24 by a horizontal insertion above the locating members 46 and 48, then lowered until the microplate 30 rests upon the shelving members 44. The robotic microplate hander 26 is then lowered to remove contact with the microplate 30, and finally removed from the microplate storage hotel 24. If the microplate 30 is misplaced into the shelving slot 50 so that one edge of the microplate 30 rests upon a pair of locating members 46 and 48, the microplate 30 will tend to slide down the angled locating members 46 and 48 until it properly rests upon the shelving members 44 in the shelving slot 50.

As can be seen in FIG. 5, insertion and removal of microplates 30 can occur from both the front and back of the microplate storage hotel 24 because there is no obstruction of either the front entrance or back entrance; therefore the microplate storage hotel 24 is pass-through capable. This allows the robotic microplate handler 26 (see FIG. 2) access to one side of the microplate storage hotel 24 and manual access from the other side of the microplate storage hotel 24.

Also visible in FIG. 5 is the positioning slot 54 which is located on the front of the base plate 40.

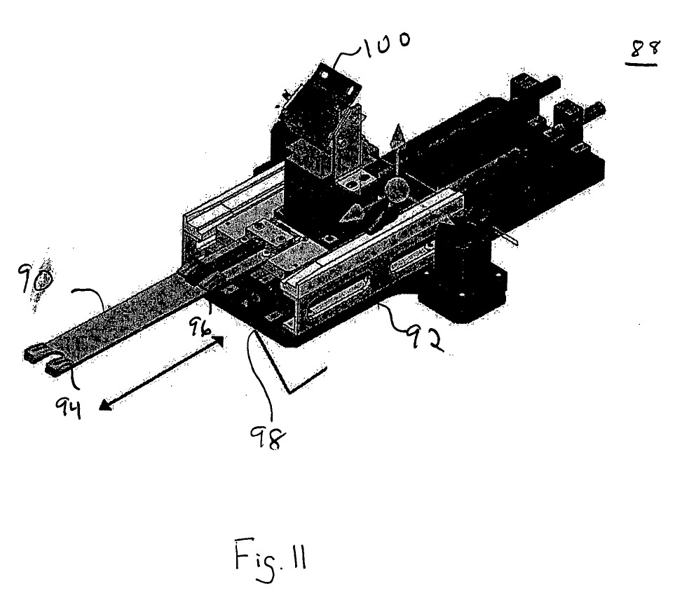

FIG. 6 is an isometric view of the side panel 36 that shows that the shelving members 44, the locating members 46 and 48, and the locking flap 62 are all integrated into to the side panel 36. Furthermore, FIGS. 6 and 7 show the location of the two bottom attachment points 68 and the two top attachment points 70. As mentioned above, the one-piece construction of the side panel 36 results in precision and reproducibility in terms of shelving member 44 position and alignment, as well as precision and reproducibility of locating member 46 and 48 position and alignment. Because the automated insertion and removal of microplates 30 (see FIG. 1) from the microplate storage hotel 24 (see FIG. 1) is facilitated by accurate positioning of the microplates 30 in the hotel 24, this integration of features in the side panel 36, along with the integrated features of the base plate 40 that are shown in detail in FIG. 9, enhances the overall performance of the microplate storage system and reduces the possibility of a machine failure during the insertion and removal process.

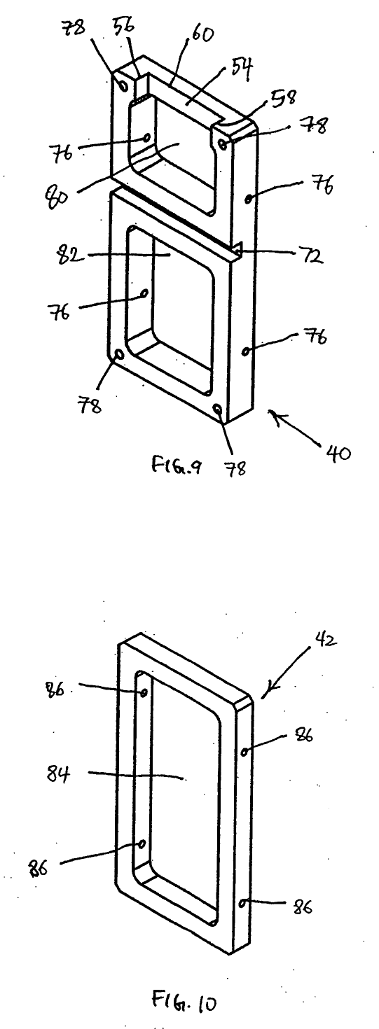

FIG. 7 provides a side view and FIG. 8 provides a front view of the side panel 36. FIG. 8 shows the locating members 46 and 48 slanted approximately at a 45 degree angle. However, other slant angles are also suitable and can be used in accordance with an embodiment of the invention.

FIG. 9 shows an isometric view of the base plate 40 with the positioning slot 54 at the top of the figure and the alignment slot 72 running across the middle. Four base plate 40 attachment points 76 that connect the base plate 40 with the side panels 36 and 38 (see FIG. 3) are visible in FIG. 9. Also visible are the four stationary attachment points 78 that serve to anchor the microplate storage hotel 24 (see FIG. 3) in a fixed position. The stationary attachment points 78 are used when the microplate storage hotel 24 will not be moved during the operation of the automated plate storage and imaging apparatus 20 (see FIG. 1). Bolts can be used to fasten the base plate 40 to the system frame 22 (see FIG. 1).

Also shown are the three edges 56, 58 and 60 of the positioning slot 54 that are used to determine the microplate storage hotel's 24 position in space: the left edge 56 of the positioning slot 54, the right edge 58 of the positioning slot 54, and the top edge 60 of the positioning slot 54. For example, in one embodiment of the invention an optical sensor located on the robotic microplate handler 26 (see FIG. 2) can be used to locate either the left edge 56 or right edge 58 of the positioning slot 54, and then the top edge 60 of the positioning slot 54. Then the information collected by the optical sensor can be analyzed by the motion controller 29 (see FIG. 1) to determine the microplate storage hotel's 24 position in space.

The alignment slot 72 shown in FIG. 9 runs across the middle of the bottom face of the base plate 40. A corresponding alignment bar in one embodiment of the invention fits into the alignment slot 72 to align and the microplate storage hotel 24 (see FIG. 1) with respect to other microplate storage hotels 24 and the system frame 22 (see FIG. 1).

FIG. 9 shows the front base plate hollow 80 and the rear base plate hollow 82 which serves to decrease the weight of the base plate 40, and in some embodiments of the invention, to decrease the amount of material needed to construct the base plate 40.

FIG. 10 shows an isometric view of the top plate 42. Like the base plate 40 depicted in FIG. 9, the top plate 42 also has a hollow 84 that functions to decrease the weight of the top plate 42, and in some embodiments of the invention, to decrease the amount of materials needed to construct the top plate 42. Finally, four top plate 42 attachment points 86 that connect the top plate 42 with the side panels 36 and 38 (see FIG. 3) are shown.

Although an example of the microplate storage hotel 24 (see FIG. 1) is shown using microplates 30 (see FIG. 1), it will be appreciated that other objects can be stored in the hotel 24. Also, although the microplate storage hotel 24 is useful to store microplates 30 at high densities, it can also be used store other objects at high densities in a cost effective manner.

FIG. 11 is an illustration of a labware handling mechanism 88 in accordance with an embodiment of the present invention. The labware handling mechanism 88 is located within the automated protein crystallizer or chamber and is configured to locate and move labware located within the storage hotels.

The labware includes a spatula 90 that is movable about a plane such that it is able to place or retract the labware from the storage hotels. This figure illustrates the spatula 90 in the extended position relative to the base 92 of the labware handling mechanism 88. The spatula 90 further includes retainment mechanisms 94, 96 in order to secure the labware firmly onto the spatula 90.

In use, the labware handling mechanism 88 moves the spatula 90 to the extended position to retrieve or place the labware from or to the storage hotel. In the retrieval mode, the labware handling mechanism 88 positions the microplate on the spatula 90. The labware is extracted from the hotel as the labware handling mechanism 88 retracts the spatula 90 into the base 92 such that the microplate is positioned in base 92.

In the preferred embodiment, the labware handling mechanism 88 further includes a sensor 98. The sensor 98 is a photoelectric sensor used to accurately locate the relief 54 on hotels 24 (see FIG. 3) or other devices utilizing a similar relief 54 inside the storage and imaging apparatus 20 (see FIG. 1). In alternative embodiments of the present invention, the sensor 98 can also be any sensor or device capable of determining a feature located on an object within its proximity.

The labware handling mechanism 88 can include the barcode reader 100, such as an infrared device. The barcode reader 100 is positioned on the labware handling mechanism 88 such that is capable of detecting and extracting information from an identification tag located on a hotel 24, a microplate 30, or any other device in the system requiring automated detection or validation. In an alternative embodiment of the present invention, the bar code reader 100 can be a radio frequency (RF) reader or any other wireless device that is able to extract data from a tag placed on a device such as the hotel 24 in order to extract or retrieve information therein.

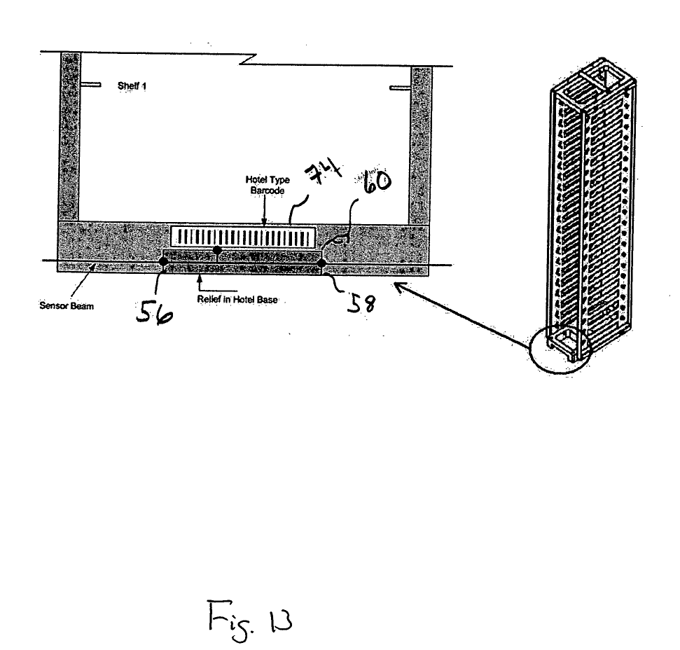

FIG. 12 is an illustration of the mechanical system 102 that enables the labware handling mechanism 88 to be translated in a number of directions in accordance with an embodiment of the present invention. The labware handling mechanism 88 is positioned on the first track system 104 to enable the labware handling mechanism 88 to be move in a first direction, which is a vertical direction. This position enables the labware handling mechanism 88 to access and service differing heights of hotels or hotels that are stacked upon each other.

The second track 106 enables the handling mechanism to be move in a second direction. In the preferred embodiment, the second direction is in a horizontal direction. Usually, this permits the labware handling mechanism 88 to service hotels that are positioned side to side.

The labware handling mechanism 88 also is able to service multiple sides of the chamber by rotating the first track 104 about the base 108 to which it is linked. In alternative embodiments of the present invention, the second track 106 is located in the chamber such as in a U-configuration and therefore enables the labware handling mechanism 88 to service all sides of the chamber.

FIG. 13 is a front view of the microplate storage hotel 24 illustrating a relief and identification tag in accordance with an embodiment of the present invention. In this figure, the sensor 98 positioned on the labware handling mechanism 88 scans each hotel 24 for a specific known positioning slot 54 or relief. In the initial scan in the preferred embodiment, the labware handling mechanism 88 scans for the left edge 56 or the right edge 58 by translating in a linear path along the second track system 106 or in a radial path around the base 108. Once it has determined either of these edges, 56 or 58, the labware handling mechanism 88 searches or scans for a vertical edge 60 through the first track 104.

The sensor 98 scans for the relief 54 by emitting a light from the sensor 98 such as infrared. A receiver or detector, which is part of the sensor 98, receives any reflection, which is subsequently analyzed. In the present invention, the light is emitted against the solid surface of the base of the hotel. A known reflection or voltage level is received back from the reflecting light on the solid surface. In the instance that this known level is not reached, the labware handling mechanism 88 assumes that it has possibly detected the relief 54. At this point, the labware handling mechanism 88 attempts to determine if it has detected the relief 54 by searching for its outer boundaries such as the left edge 56, right edge 58, and top or vertical edge 60.

The structure of the relief is similar from one hotel to another, and the edges or geometrical distances are known. To automatically detect the presence of devices in the system, the motion controller 29 (see FIG. 1) moves the labware handling mechanism 88 to a point inside of a known relief 54. The motion controller 29 then moves the mechanical system 102 (see FIG. 12) to allow the sensor 98 to search for relief features. It expects the sensor 98 to detect the left edge 56 or right edge 58 within a specific distance from its initial starting point, followed by detecting the top edge 60 within a specific distance vertically, positively identifying a relief 54. Once a relief is positively identified, the motion controller 29 moves the labware handling mechanism 88 past the relief 54 and begins another search path for the next relief 54. Pre-configured zones within the storage and imaging apparatus 20 (see FIG. 1) are searched in this manner until no relief features 54 are found within an appropriate distance. Therefore, if an edge is not detected within a specific distance, then the labware handling mechanism assumes that a relief was not detected and that there are no other storage hotels or other devices utilizing a relief 54 remaining in that zone. In another embodiment, the top edge 60 is the first feature of a relief 54 searched for, followed by a search path identical to the process described above. This embodiment can be useful for applications where the vertical position of a relief 54 can be more accurately determined initially than the horizontal position can be determined.

It is noted that the distance from the labware handling mechanism 88 to the storage hotel is fixed such that the known response or reflection is received. In the preferred embodiment, this fixed position can be done by a mechanical setup. In alternative embodiments, the lab handling mechanism 88 is moved in the direction of the storage hotel until such time that it comes in contact with the hotel or the hotel base such that it stalls against the hotel.

The relief 54 is located at the base of the hotel in the preferred embodiment. It is noted that the relief, in alternate embodiments, can be located in the top or any other areas on the hotel.

Upon the detection of the relief 54, the labware handling mechanism 88 proceeds to scan or read an identification tag 74 that is positioned above the relief 16. In the preferred embodiment, the identification tag 54 is a barcode that is read by the barcode reader 100 that is positioned in the labware handling mechanism 88. By scanning the identification tag 74 with the barcode reader 100, information about the storage hotel is extracted and provided to the chamber operating system. This information is crosslinked with data entered into the system. The location of the hotel is then provided and stored in the chamber operating system so that quick and efficient access is accomplished. Therefore, if a specific piece of labware such as a microplate is needed, then operating system can instruct the labware handling mechanism to the specific location of the hotel to where it is located.

The position of the identification tag 74 is known relative to the relief 54 in the preferred embodiment. The bar code reader 100 is positioned in the labware handling system such that upon detection of the edges of the relief, the identification tage 74 is located at a known position relative to the relief. This position eliminates the need to further search for additional features on the hotel.

As noted, the identification tag 74, in the preferred embodiment, is located on the base of the storage hotel. In alternative embodiments of the present invention, additional spaces for the identification tag 74 can be provided at the top or any other position on the hotel. Locating the identification tag 74 in the proximity of the relief is preferable as it simplifies the overall system. However, it is noted that is not a necessary feature of the present invention.

In an alternative embodiment of the present invention, a RF reader can be positioned on the labware handling mechanism or within specific locations with the chamber. In the former configuration, a corresponding radio frequency identification (RFID) tag is located on each hotel. The reader is actuated such that it can only request information or data from hotels within its immediate vicinity. Therefore, the reader will not receive multiple responses from an initial request. Upon receiving the request, the RFID would provide the data requested. The RFID has additional capabilities in that it can provide more differing types of data such as requestor, time of request, incubation time or other customized data as desired.

By locating multiple RFID readers within the chamber and not on the labware handling mechanism 88, the chamber operating system is able to ping the RFID tags and triangulate the location of the hotels. Therefore, it is able to determine the location as well as provide the additional benefits noted above.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for detecting the type of storage unit, comprising:
a storage unit; and
a relief located on the storage unit, wherein the relief is configured to locate the position of the storage unit; and
a sensor that is configured to detect the relief.

2. The apparatus as in claim 1, wherein the relief is located on a base of the storage unit.

3. The apparatus as in claim 1, wherein the relief is located on the top of the storage unit.

4. The apparatus as in claim 2, wherein the storage unit is a hotel.

5. The apparatus as in claim 4, wherein the hotel is configured to store labware.

6. The apparatus as in claim 5, wherein the hotel is positioned within an incubation chamber.

7. The apparatus as in claim 4, wherein the relief comprises a left edge, a right edge and a top.

8. The apparatus as in claim 7, wherein the sensor detects the relief by detecting the left edge and/or the right edge, then the top.

9. The apparatus as in claim 8, wherein an identification tag is located on the base above the top of the relief.

10. The apparatus as in claim 9, wherein the identification tag is a barcode.

11. The apparatus as in claim 9, wherein the relief and the barcode are used to determine the type of hotel.

12. The apparatus as in claim 1, wherein the sensor is located located on a handler.

13. The apparatus as in claim 12, wherein the sensor is a photoelectric sensor.

14. The apparatus as in claim 9, wherein the sensor is configured to located the identification tag in response to detecting the relief.

15. A method for detecting the type of storage unit, comprising:
ascertaining a location for a relief in the storage unit; and
in response to locating the relief, determining the type of storage unit.

16. The method as in claim 16, wherein the step of ascertaining comprises determining a left edge of the relief and/or determining a right edge of the relief, and determining a top edge of the relief.

17. The method as in claim 16, wherein the steps of determining the left edge, the right edge and the top edge are accomplished with a sensor.

18. The method as in claim 17, wherein the sensor is a photoelectric sensor.

19. The method as in 16, wherein the step of determining comprises locating an identification tag in the proximity of the relief and extracting information from the identification tag.

20. A system for detecting the type of storage unit, comprising:
means for ascertaining a location for a relief in the storage unit; and
means for determining the type of storage unit.

21. The system as in claim 20, wherein the means for ascertaining is configured to determine a left edge of the relief and/or a right edge of the relief, and determine a top edge of the relief.

22. The system as in claim 20, wherein the means for determining the left edge and/or the right edge and the top edge is accomplished with a sensor.

23. The system as in claim 22, wherein the sensor is a photoelectric sensor.

24. The system as in 20, wherein the means for determining is configured to locate an identification tag in the proximity of the relief and extract information from the identification tag.
